(19) United States
(12) Patent Application Publication
(10) Pub. No.: US 2026/0097401 A1
(43) Pub. Date: Apr. 9, 2026

(54) SAWTOOTH INERTIAL DEVICE

(71) Applicant: Astrin Biosciences, Inc., St. Paul, MN (US)

(72) Inventors: Mahdi Ahmadi, Minneapolis, MN (US); Judith Kaylee Kamalanathan, Woodbury, MN (US); Jiarong Hong, Eden Prairie, MN (US); Nicholas Heller, New Brighton, MN (US); Anthony Clacko, Eden Prairie, MN (US); Jayant Parthasarathy, Excelsior, MN (US)

(73) Assignee: Astrin Biosciences, Inc., St. Paul, MN (US)

(21) Appl. No.: 19/113,975

(22) PCT Filed: Sep. 22, 2023
(86) PCT No.: PCT/US2023/074932

§ 371 Date: Mar. 21, 2025

Related U.S. Application Data
(60) Provisional application No. 63/408,963, filed on Sep. 22, 2022.

(51) Int. Cl. B01L 3/00; G01N 15/00; G01N 15/01; G01N 15/02; G01N 15/14

(52) U.S. Cl. CPC B01L 3/502761; G01N 15/01; G01N 15/0255; G01N 15/1459; G01N 15/1484; B01L 2200/0652; B01L 2300/0864; B01L 2300/0883; G01N 2015/0053

(57) ABSTRACT

The present embodiments relate to a particle separation device. The particle separation device can include an inlet, a main channel comprising a series of angled portions to separate particles of varying sizes and varying flow rates. The particle separation device can also include a number of outlets to obtain particles of varying sizes. In some instances, the main channel can include multiple stages to allow for multi-stage sorting to increase sorting performance.

### PRIORITY

This application claims the benefit of U.S. Ser. No. 63/408,963, filed on Sep. 22, 2022, which is incorporated herein by reference in its entirety.

### TECHNICAL FIELD

The methods and compositions described here relate to the field of inertial microfluidic devices. More particularly, embodiments relate to a resistor particle separation device for sorting micro particles of varying sizes with varying flow rates.

### BACKGROUND

Inertial microfluidic techniques can generally be used to separate particles based on a size of the particles. For example, an inertial microfluidic device can obtain a number of microparticles with varying flow rates and separate the microparticles by size. More efficient methods of inertial separation of particles including cells are needed in the art.

### SUMMARY

The present embodiments relate to a particle separation device. In one embodiment, a particle separation device is described. The particle separation device can include an inlet for receiving particles of varying sizes across varying flow rates. The particle separation device can also include a main channel comprising a first end and a second end. The first end can be connected to the inlet.

The main channel can comprise a series of angled portions. Each of the angled portions can form an angle that can be acute or obtuse (e.g., comprising angles between 1-89 degrees, or between 91 and 179 degrees) relative to an adjacent angled portion. The main channel can be configured to provide an inertial separation of the particles received at the inlet. The series of angled portions can reduce a pressure in the particle separation device and control varying flow rates of particles received at the inlet.

The particle separation device can also include one or more outlets connected to a second end of the main channel. Each of the one or more outlets can be configured to receive separated particles of differing sizes and/or densities.

In some instances, at least a portion of edges connecting each of the series of angled portions with the adjacent angled portion are rounded.

In some instances, the particle separation device can include between three and five outlets.

In some instances, the main channel comprises: a first stage and a second stage, wherein both the first stage and the second stage of the main channel are directly connected to at least one of the outlets.

In some instances, a second channel is disposed between the first stage and the second stage of the main channel, the second channel connecting to a first outlet.

In some instances, a second channel is disposed between the first stage and the second stage of the main channel, the second channel including two open ends, with each open end connecting to corresponding outlets.

In some instances, the particle separation device comprises a height of 50 micrometers and a width of between 100-200 micrometers.

In some instances, the particle separation device is configured to operate in a laminar flow regime and a transitional flow regime.

In some instances, the particle separation device includes a Reynolds number that is less than or equal to 2000 (e.g., less than about 2,000, 1,750, 1,500, 1,250, 1,000, 750, 500, or 250).

In some instances, the one or more outlets are either disposed in-line with the main channel or are disposed offset relative to a direction of the main channel. In an aspect an outlet is offset from a main channel by about 20, 30, 45, 50, 60, 70, 80, 90, 100, 120, 130, 140, 150, 160, 170, or 175 degrees, but any amount of offset is contemplated.

In another example embodiment, a system for separating particles of varying sizes and/or inertia across varying flow rates using inertial separation is provided. The system can include an inlet and a main channel connected to the inlet at a first end of the main channel. The main channel can include a series of angled portions. Each of the angled portions can form an angle that is greater than 90 degrees to an adjacent angled portion The system can also include a set of outlets connected to a second end of the main channel.

In some instances, at least two of the series of angled portions including angles that are either less than or greater than 90 degrees form a trapezoidal corner.

In some instances, a first portion of the series of angled portions form trapezoidal corners and a second portion of the series of angled portions include rounded edges.

In some instances, at least one edge connecting each of the series of angled portions with adjacent angled portions is rounded. The angled portions can be trapezoidal wave shaped or sawtooth wave shaped. The angled portions can have a wavelength of 0.1 mm to 5 mm. The main channel can have a width of 50 to 600 micrometers and a depth of 30 to 70 micrometers.

In another example embodiment, a device is provided. The device can include an inlet for receiving particles of varying sizes across varying flow rates. The device can also include a main channel comprising a first stage and a second stage, with a first end of the first stage of the main channel connected to the inlet. The main channel can include a series of angled portions. The main channel can be configured to provide an inertial separation of the particles received at the inlet. The device can also include at least two outlets, with at least a first outlet connected to the first stage of the main channel and a second outlet connected to the second stage of the main channel.

In some instances, each of the angled portions forming an angle with an adjacent angled portion that is either less than or greater than 90 degrees.

In some instances, the first stage comprises angled portions forming angles less than 45 degrees and the second stage comprises angled portions that are greater than 90 degrees forming trapezoidal corners.

In some instances, any of the first stage or second stage comprises angled portions forming angles less than 45 degrees that form trapezoidal corners. The angled portions can be trapezoidal wave shaped or sawtooth wave shaped. The angled portions can have a wavelength of 0.1 mm to 5 mm. The main channel can have a width of 50 to 600 micrometers and a depth of 30 to 70 micrometers.

An aspect provides a particle separation device comprising an inlet for receiving particles of varying sizes and/or differing inertia across varying flow rates; a main channel comprising a first stage and a second stage, the first stage comprising a first end connected to the inlet and a second end connected to the second stage, the second stage comprising 2, 3, 4, 5, or more channels each connected to one or more outlets, wherein the first stage comprises a channel comprising a series of angled portions, with each of the angled portions forming an angle of either less than or greater than 90 degrees to an adjacent angled portion, where the angle formed in the first stage channel is configured to provide an inertial separation of the particles, wherein the channels of the second stage comprise a series of angled portions, with each of the angled portions forming an angle of either less than or greater than 90 degrees to an adjacent angled portion, where the angle formed in the second stage channels is configured to provide an inertial separation of the particles, wherein each of the one or more outlets is configured to receive separated particles of differing sizes and/or differing inertia. The series of angled portions of the first stage channel can be different from the series of angled portions of the second stage channels. The series of angled portions of the first stage channel can be trapezoidal wave shaped, and the series of angled portion of the second stage channels can be sawtooth wave shaped. The series of angled portions of the first stage channel can be sawtooth wave shaped, and the series of angled portion of the second stage channels can be trapezoidal wave shaped. The angled portions can have a wavelength of 0.1 mm to 5 mm.

An aspect provides a particle separation device comprising an inlet for receiving particles of varying sizes and/or differing inertia across varying flow rates; a main channel comprising a first stage, a second stage, and a third stage. The first stage can comprise a first end connected to the inlet and a second end connected to the second stage, the second stage comprising 2, 3, 4, 5, or more channels each connected to one or more outlets and one channel connected to the third stage. The third stage can comprise 2, 3, 4, 5, or more channels each connected to one or more outlets, the first stage can further comprise a channel comprising a series of angled portions, with each of the angled portions forming an angle of either less than or greater than 90 degrees to an adjacent angled portion, where the angle formed in the first stage channel is configured to provide an inertial separation of the particles. The channels of the second stage can comprise a series of angled portions, with each of the angled portions forming an angle of either less than or greater than 90 degrees to an adjacent angled portion, where the angle formed in the second stage channels is configured to provide an inertial separation of the particles. The channels of the third stage can comprise a series of angled portions, with each of the angled portions forming an angle of either less than or greater than 90 degrees to an adjacent angled portion, where the angle formed in the third stage channels is configured to provide an inertial separation of the particles, wherein each of the one or more outlets is configured to receive separated particles of differing sizes and/or differing inertia. The series of angled portions of the first stage channel can be trapezoidal wave shaped or sawtooth wave shaped, the series of angled portions of the second stage channels can be trapezoidal wave shaped or sawtooth wave shaped, and the series of angled portions of the third stage channels can be trapezoidal or sawtooth wave shaped. The angled portions can have a wavelength of 0.1 mm to 5 mm.

An aspect provides a method for separating one or more particles from a mixture of particles suspended in a liquid, comprising introducing the mixture into an inlet of a particle separation device described herein and collecting particles from the one or more outlets. The particles can be cells or a mixture of cells. The cells can be blood cells, stem cells, bone marrow cells, circulating tumor cells, released tumor cells, or mixtures thereof.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates an example particle separation device with a sawtooth design according to an embodiment.

FIG. 2 illustrates an example particle separation device with a softened sawtooth design according to an embodiment.

FIG. 3 illustrates an example particle separation device with a trapezoidal design according to an embodiment.

FIG. 4 illustrates an example particle separation device with a double stage sawtooth design with a closed end outlet disposed between stages according to an embodiment.

FIG. 5 illustrates an example particle separation device with a double stage sawtooth design with open end outlets disposed between stages according to an embodiment.

FIG. 6 is an example particle separation device according to a first example embodiment.

FIG. 7 is an example particle separation device with outlets disposed at an angle relative to the main channel of the device according to a second example embodiment.

FIG. 8 is an example particle separation device according to a third example embodiment.

FIG. 9 is an example particle separation device according to a fourth example embodiment.

FIG. 10 is an example particle separation device according to a fifth example embodiment.

FIG. 11 is an example particle separation device according to a sixth example embodiment.

FIG. 12 is an illustration of blood components and white blood cells (WBCs) in a particle separation device according to an embodiment.

FIG. 13A is a first example illustration of blood components in a brightfield image and a fluorescence image in a particle separation device.

FIG. 13B is a second example illustration of blood components in a brightfield image and a fluorescence image in a particle separation device.

FIG. 14A illustrates a first example orientation of outlets that are part of a particle separation device according to an embodiment.

FIG. 14B illustrates a second example orientation of outlets that are part of a particle separation device according to an embodiment.

FIG. 15 illustrates an example particle separation device with edges of a main channel forming a trapezoidal shape according to an embodiment.

FIG. 16 illustrates an example of a two-stage trapezoidal-sawtooth inertial (TSI) sorter device.

FIG. 17 shows depletion of red blood cells in both stages of a TSI device (e.g., a device as shown in FIG. 16).

FIG. 18 shows focusing of cancer cell lines in the first stage of a TSI device. Because the cancer cell lines are fluorescent, they display as bright lines in the device. The numbers to the left of the images are μL/min for that specific image.

FIG. 19 shows an example of a two-stage sawtooth-trapezoidal inertial (STI) sorter device.

FIG. 20 shows focusing of cancer cells in the first stage of an STI device.

FIG. 21 shows focusing of cancer cells in the second stage of an STI device.

FIG. 22 shows depletion of red blood cells in the first stage of an STI device.

FIG. 23 shows depletion of red blood cells in the second stage of an STI device.

FIG. 24 shows an example of a sawtooth-sawtooth-sawtooth inertial (SSSI) sorter device.

FIG. 25 shows focusing of cancer cell lines in the first stage of an SSSI device (e.g., FIG. 24).

FIG. 26 shows focusing of cancer cell lines in the second stage of an SSSI device (e.g. FIG. 24).

FIG. 27 shows depletion of red blood cells in the first two stages of an SSSI device (e.g., FIG. 24).

### DETAILED DESCRIPTION

Inertial microfluidics can be used to take advantage of hydrodynamic forces that act on particles such as cells to focus them within a flow. The hydrodynamic forces can cause particles to migrate across streamlines and order in equilibrium positions based on their size, such that the particles can be separated, purified, and/or enriched in a microfluidic device. A transitional flow regime in channel flows lies between laminar and turbulent flow where the flow characteristics show fluctuations and disturbances, but the flow is not fully turbulent. In the context of Reynolds number, the Reynolds number of transitional flow is typically above that for laminar and below that for turbulent flows. The exact Reynolds numbers demarcating these regimes can vary based on several factors, including the roughness of the channel, disturbances in the flow, and other conditions.

Devices incorporating inertial microfluidic techniques can operate in a laminar flow regime and can rely on a balance of an inertial lift force and a wall force to focus particles to distinct streamlines. The location of the streamlines can vary based on any of a channel geometry, particle characteristics, and/or fluid characteristics. For instance, in straight cylindrical channels, particles can focus to an inner circle a specific distance from the channel wall. In a square channel, the particles can focus to any of four locations equidistant to one another. By changing a cross-sectional area to be rectangular, the locations can often collapse into two locations. Adding curvature can further increase an ability to optimize the focusing of various particle types to different streamlines.

The effect caused by the balance of lift forces arising from the curvature of the parabolic velocity profile (the shear-induced inertial lift) and the interaction between particles and the channel wall (the wall-induced lift) can be utilized for particle separation. For example, for particles of diameter aₚ in a channel of diameter D, the net lift force scales as F_{L}∝C_{L}aₚ⁴, where C_{L} is the lift-co-efficient. The strong dependence of the lift forces on size offers an ability to perform separation in a continuous, flow-through manner at low cost and high efficiency.

Based on a specific sample (e.g., a blood sample or cell suspension) and the desired outcome, different inertial designs can be optimal. For example, preserving cells early in the process has potential benefits or causes problems dependent on the target application. This preservation process alters the mechanical characteristics of the cells such as size and deformability which changes how cells will focus in a specific device design at the target flow rate meaning just because a device works for one cell population does not necessarily mean it is optimized for another application. Additionally, different designs operate at various flow rates and cell densities resulting in varying output volume and processing time. Provided herein are various microfluidic device configurations to meet our varied specimen types, cell density, and processing speed requirements.

Inertial microfluidic devices can be used to separate particles by a difference in an inertia of the particles or a size of the particles. Flow patterns can be characterized by a set of equations: Reynold's Number, Particle Reynold's Number, Combined Lift Force, and Dean's Number. Reynold's Number

$$Re = \frac{ρ uL}{μ}$$

can indicate the laminarity of the flow, because it is the ratio of inertial to viscous forces. If the inertial forces outpower the viscous forces (Re>2000), then mixing can occur and particles may not focus to predictable streamlines. Because particles of different sizes experience inertial and viscous forces differently, particle Reynolds number

$${Re}_{p} = Re x {( \frac{{a}_{p}}{L} )}^{2}$$

can also be used to characterize the ability of particles to focus due to inertial forces. The equation that best characterizes inertial focusing is the combined lift force

$${F}_{L} = \frac{ρ {U}_{m}^{2} {a}_{p}^{4}}{{D}_{h}^{2}} {C}_{L}$$

which can consider both flow characteristics and particle information. Although the combined lift force is accurate for Newtonian fluids, it can include an experimentally determined lift coefficient which varies based on the system and it assumes rigid, relatively neutrally buoyant particles. When curvature is present in the system, the Dean's number

$$De = Re \sqrt{\frac{L}{2 {R}_{C}}}$$

can also be important as it characterizes the flow patterns that occur in curved systems. A table depicting variables used in the set of equations is provided below.

TABLE 1

| Symbol | Variable |
|---|---|
| Re | Reynolds Number |
| ρ | Density (kg/m³) |
| u | Velocity (m/s) |
| L | Characteristic Channel Length (m) |
| μ | Dynamic Viscosity (kg/m s) |
| Reₚ | Particle Reynolds Number |
| aₚ | Particle Diameter (m) |
| F_{L} | Lift Force(kg m/s²) |
| Uₘ | Maximum Velocity (m/s) |
| Dₕ | Smallest Channel Dimension (m) |
| C_{L} | Lift Coefficient |
| De | Dean Number |
| R_{C} | Radius of Curvature (m) |

The study of these parameters has led to the development of spiral and serpentine devices to focus particles for a variety of applications, such as separating cells by size. The present embodiments relate to particle separation devices that focus particles of interest to separate streamlines from the other particles in the starting solution.

In many cases, devices for separation of particles can use soft curves with large radii of curvature to right angles. However, such devices do not generally have an angle sharper than 90°. The devices as described herein can use sharp or relaxed angles (i.e., angles below or above 90°) to strengthen inertial separation. Furthermore, the devices can include repeating angles (e.g., sawtooth wave profile or trapezoidal wave profile) to achieve inertial separation for a distribution of particle sizes across a large range of flow rates. For example, angles formed in a main channel can include any acute angle between 1-89 degrees (e.g., 1, 5, 10, 15, 20, 25, 30, 40, 45, 50, 55, 60, 65, 70, 75, 80, 85, or 89 degrees), or an obtuse angle between 91-179 degrees (e.g., 91, 95, 100, 105, 110, 115, 120, 125, 130, 135, 140, 145, 150, 155, 160, 165, 170, 175, or 179 degrees). Other embodiments of the device can utilize acute or obtuse angles in the shape of a trapezoid to achieve particle separation.

A variety of flow rates can be used, for example a flow rate can be in a range of between about 0.1 mL/min to about 1 L/min. High throughput can be achieved by combining multiple channels in a variety of combinations. Therefore, a throughput flow rate can be about 0.1 mL/min, about 0.5 mL/min, about 1.0 mL/min about 5 mL/min, about 10 mL/min, about 20 mL/min, about 40 mL/min, about 50 mL/min, about 100 mL/min, about 200 mL/min, about 300 mL/min, about 400 mL/min, about 500 mL/min, about 600 mL/min, about 700 mL/min, about 800 mL/min, about 900 mL/min, about 1 L/min, or more.

Device designs can include various embodiments. For instance, a first set of example embodiments can relate to single-stage sorting inertial separation devices. A first example design can incorporate a sawtooth design, a second example design incorporates a soft-edge sawtooth design, and a third example design incorporates a trapezoidal design.

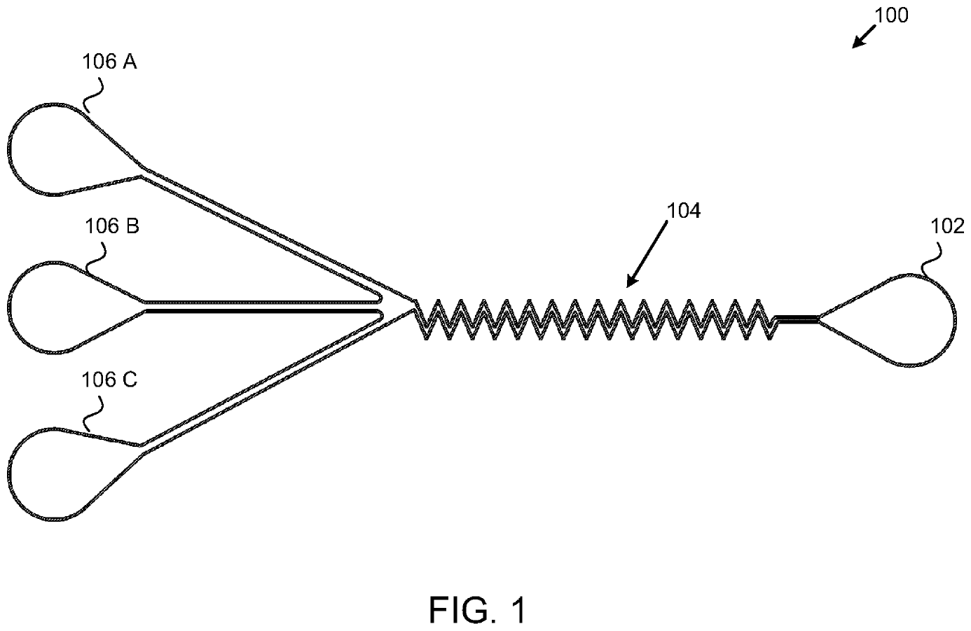

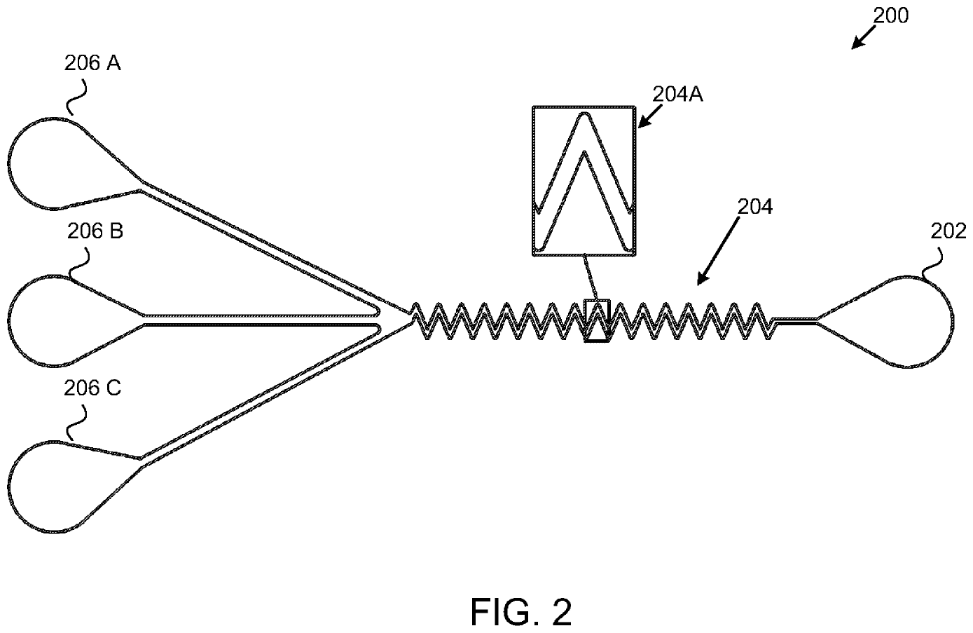

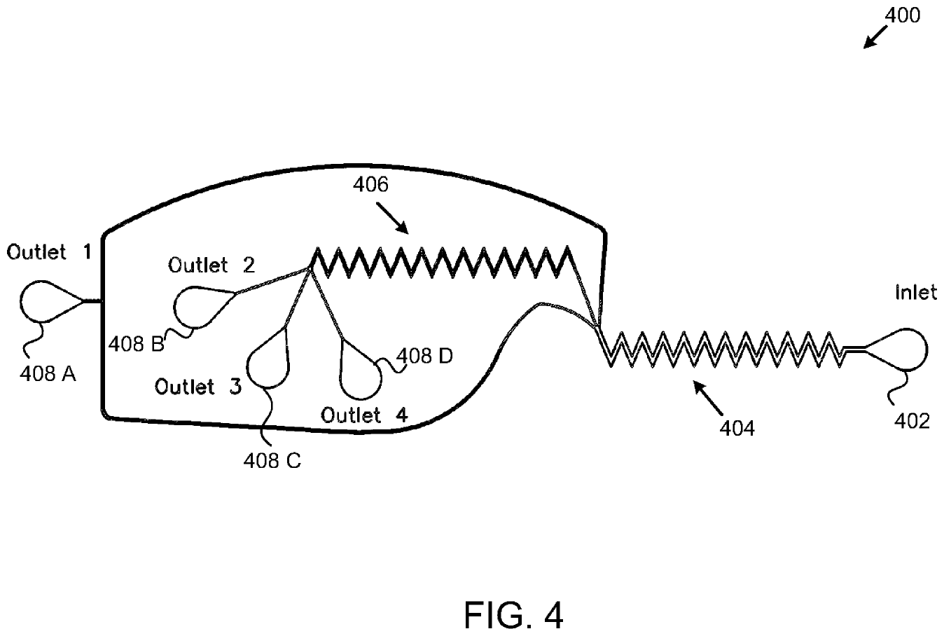

FIG. 1 illustrates an example particle separation device 100 with a sawtooth design. In an aspect any sawtooth channel for any device described herein can comprise sawtooth wave or edges. Here, a sawtooth wave channel is comprised of repeating V-shaped angles (see 204A of FIG. 2) (e.g., about 2, 5, 10, 15, 20, 30, 40, 50, 60, 70, 80, 90, 100, 150, 200 or more V-shaped angles). The wavelength (the distance between crests or troughs) can be about 0.01, 0.1, 0.2, 0.25, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 4.0, 4.5, 5.0 mm or more. This type of channel can be used in any device described herein (e.g., as a first, second or third stage as shown in FIGS. 4-10, 14, 16, 19, and 24). As shown in FIG. 1, the device 100 can include an inlet 102, a main channel 104, and multiple outlets 106A-C. For example, particles of varying sizes can be provided at the inlet 102, travel through the main channel and be output at outlets 106A-C based on a size of each particle. In some embodiments, the outlets 106A-C can include channels in and of themselves, as the outlets can comprise both a channel separate from the main channel as well as an outlet from the main channel.

FIG. 2 illustrates an example particle separation device 200 with a softened sawtooth design. For instance, as shown in FIG. 2, the main channel 204 can include a soft-edge sawtooth design. This type of channel can be used in any device described herein (e.g., as a first, second or third stage as shown in FIGS. 4-10, 14, 16, 19, and 24). The main channel 204 can include a number of edges or wave forms (e.g., 204A) for single stage sorting. Softened edges means that the peaks and valleys of a waveform (e.g., a sawtooth wave) are slightly rounded or curved.

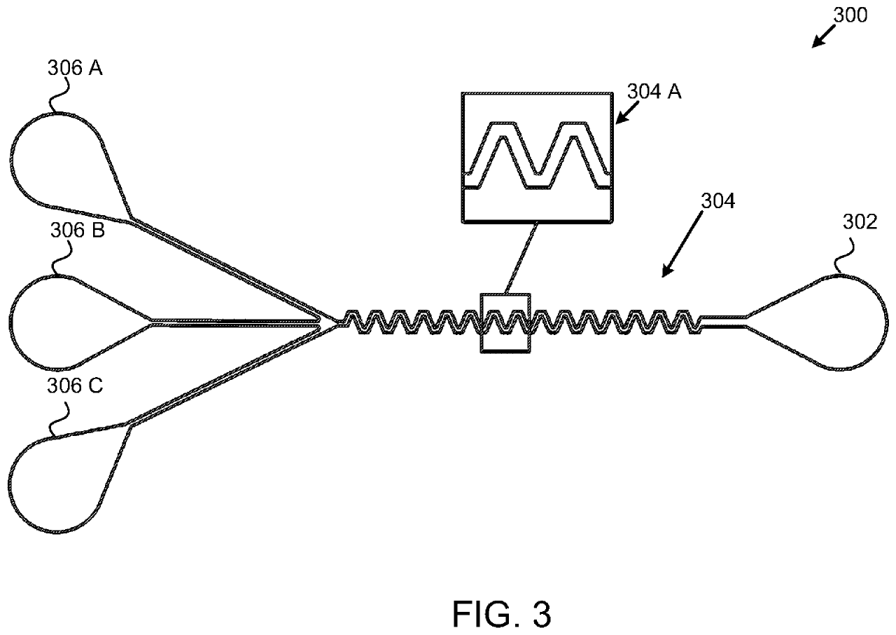

FIG. 3 illustrates an example particle separation device 300 with a trapezoidal design. As shown in FIG. 3, the main channel 304 can include edges or waveforms (e.g., 304A) forming a trapezoidal design. In an aspect any trapezoid channel for any device described herein can comprise a trapezoidal shape. Here, a trapezoidal wave channel is comprised of repeating trapezoid shaped angles (see 304A of FIG. 3 showing 2 trapezoidal shapes) (e.g., about 2, 5, 10, 15, 20, 30, 40, 50, 60, 70, 80, 90, 100, 150, 200 or more trapezoidal angles). The wavelength (the distance between crests or troughs) can be about 0.01, 0.1, 0.2, 0.25, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 4.0, 4.5, 5.0 mm or more. This type of trapezoidal channel can be used in any device described herein (e.g., as a first, second or third stage as shown in FIGS. 4-10, 14, 16, 19, and 24).

In some instances, the particle separation devices can include multi-stage sorting designs. The multi-stage sorting systems can provide enhanced sorting performance in terms of increased depletion rate and/or a purity of types of sorted particles.

FIG. 4 illustrates an example particle separation device 400 with a double stage sawtooth design with a closed end outlet disposed between stages. For example, multiple stages 404, 406 of the main channel can be provided as a double stage sawtooth design with a closed end. A closed end has a merging of outlets at the end of the device to decrease the number of outlets. The design can incorporate any of the sawtooth (e.g., FIG. 1), soft-edge (e.g., FIG. 2), and/or the trapezoidal (e.g., FIG. 3) main channels as described herein. Furthermore, as shown in FIG. 4, a closed end outlet (e.g., 408A) can be connected to the main channel between the stages 404, 406. Further, outlets 408B-D can be connected to a second stage 406 of the main channel.

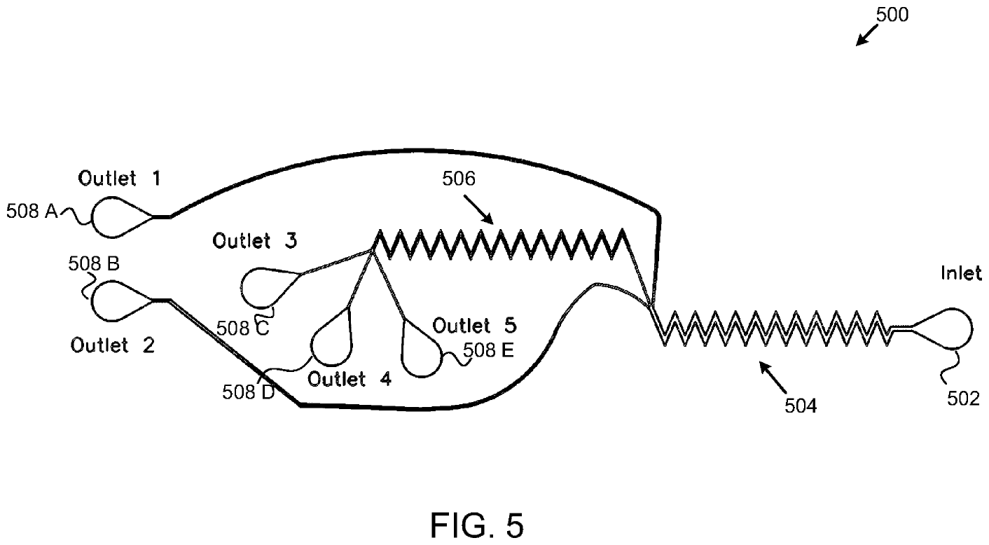

FIG. 5 illustrates an example particle separation device 500 with a double stage sawtooth design with open end outlets (i.e., each outlet is separated) disposed between stages. For example, in FIG. 5, the design can include a main channel including a first stage 504 and a second stage 506. Multiple open-end outlets 508A, 508B can be connected between stages 504 and 506. While two stages are described with respect to FIGS. 4-5, any number of stages (e.g., three stages, four stages, five stages or more) can be implemented as part of a main channel(s) of the device.

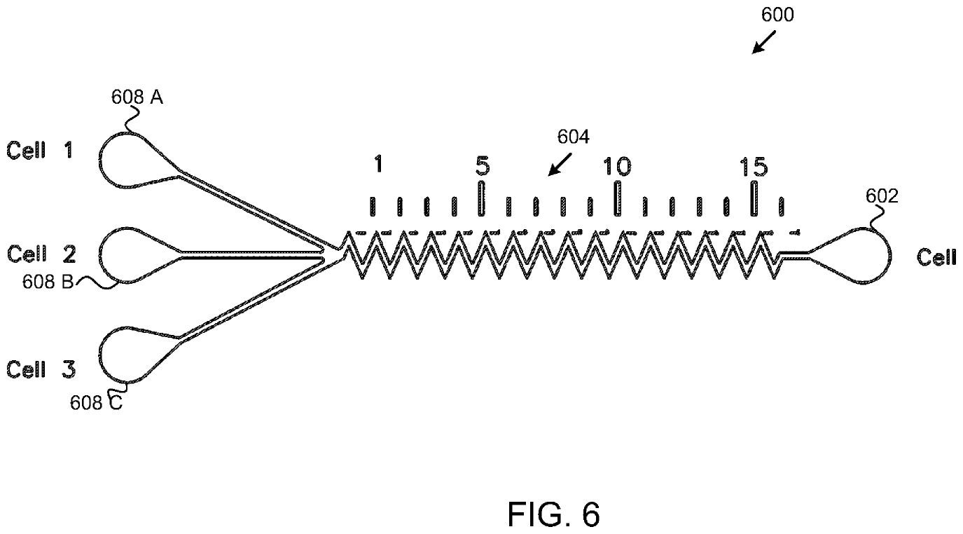

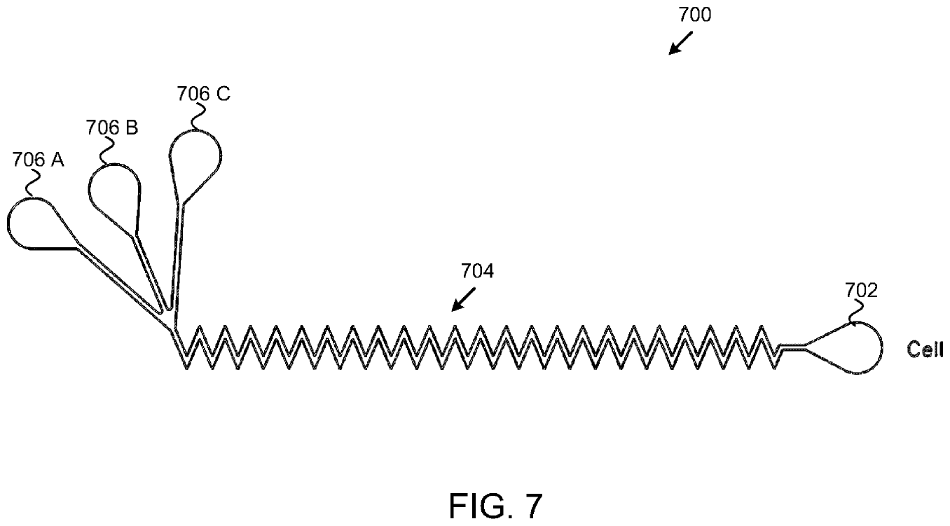

In addition to changing the channel design and dimensions, the outlet geometry can be adjusted to selectively sort out specific particles into the desired outlet channel. These modifications can include (1) the orientation of outlet channel with respect to the orientation of the channel its relative location to the sharp angle (see FIG. 7, for an example of an outlet channel having a sharp angle (compare to FIG. 6 where no sharp angle is present), (2) the expansion ratio (e.g., an expansion ratio of 1.5, 2, 3, 4, 5 or more) of the diverging channel connecting to the exit of the channel, (3) the dimensions of the outlet channels (for example the outlet channels can be varied to be about 10 μM to about 500 M (e.g., about 10, 20, 50, 100, 150, 200, 250, 300, 350, 400, 450, 500 or more μM, and (4) the difference in resistance between the various outlet channels. In general the difference in resistance can be less than one order of magnitude.

For any device described herein, a channel depth can be between about 30 μm and about 70 μm (e.g., about 30, 40, 50, 60, 70 μm micrometers. A channel width can be about 10, 20, 30, 40, 50, 60, 70, 80, 90, 100, 200, 300, 400, 500 or more micrometers. The length of a main channel or a channel stage can be about 10 mm to about 30 cm (e.g., about 10, 20, 30, 40, 50, 60, 70, 80, 90 100 mm or more, or about 1, 2, 5, 10, 15, 20, 25, 30 mm or more). The corners or waveforms can include angles of between 1-89, or between 91-179 degrees (e.g., either less than or greater than 90 degrees (e.g., any acute angle between 1-89 degrees (e.g., 1, 5, 10, 15, 20, 25, 30, 40, 45, 50, 55, 60, 65, 70, 75, 80, 85, or 89 degrees), or an obtuse angle between 91-179 degrees (e.g., 91, 95, 100, 105, 110, 115, 120, 125, 130, 135, 140, 145, 150, 155, 160, 165, 170, 175, or 179 degrees)). The devices can comprise about 1, 2, 3, 4, 5, 6, 7, 8, 9, 10, 15, 20 or more outlets. Outlets can vary widely in length from about 1 μM to about 1 M (e.g., about 1, 5, 10, 20, 30, 40, 50, 60, 70, 80, 90, 100 μM or more, or about 1, 2, 5, 10, 20, 30, 40, 50, 60, 70, 80, 90, 100 mM or more, or about 1, 2, 5, 10, 20, 30, 40, 50, 60, 70, 80, 90, 100 cm or more). The devices can comprise 1, 2, 3, 4, 5, or more inlets.

FIG. 6 is an example particle separation device 600 according to a first example embodiment. A device can have a channel depth of, e.g., about 50 micrometers, and a channel width of about 200 micrometers (but any dimensions can be used), and can flow from right to left. The length of a main channel can be about 10 mm to about 30 cm (e.g., about 10, 20, 30, 40, 50, 60, 70, 80, 90 100 mm or more, or about 1, 2, 5, 10, 15, 20, 25, 30 mm or more). The corners can include angles of between 1-89, or between 91-179 degrees, such as an angle around 45 degrees for example. The device 600 can include a main channel 604 and a series of outlets 608A-C. Outlets can vary widely in length from about 1 μM to about 1 M (e.g., about 1, 5, 10, 20, 30, 40, 50, 60, 70, 80, 90, 100 μM or more, or about 1, 2, 5, 10, 20, 30, 40, 50, 60, 70, 80, 90, 100 mM or more, or about 1, 2, 5, 10, 20, 30, 40, 50, 60, 70, 80, 90, 100 cm or more). In some instances, as shown in FIG. 6, the outlets 608A-C can be substantially in-line with the longitudinal axis of the main channel 604.

FIG. 7 is an example particle separation device 700 with outlets disposed at an angle relative to the longitudinal axis of the main channel of the device according to a second example embodiment. As shown in FIG. 7, the outlets 706A-C can be disposed at an angle relative to the main channel 704 and the inlet 702 (compare with FIG. 6 where no angle is present). The angle can be about 179, 170, 160, 150, 140, 130, 120, 110, 100, 90, 80, 70, 60, 50 or less degrees from the longitudinal axis of the main channel. This type outlet arrangement can be present in any device described herein.

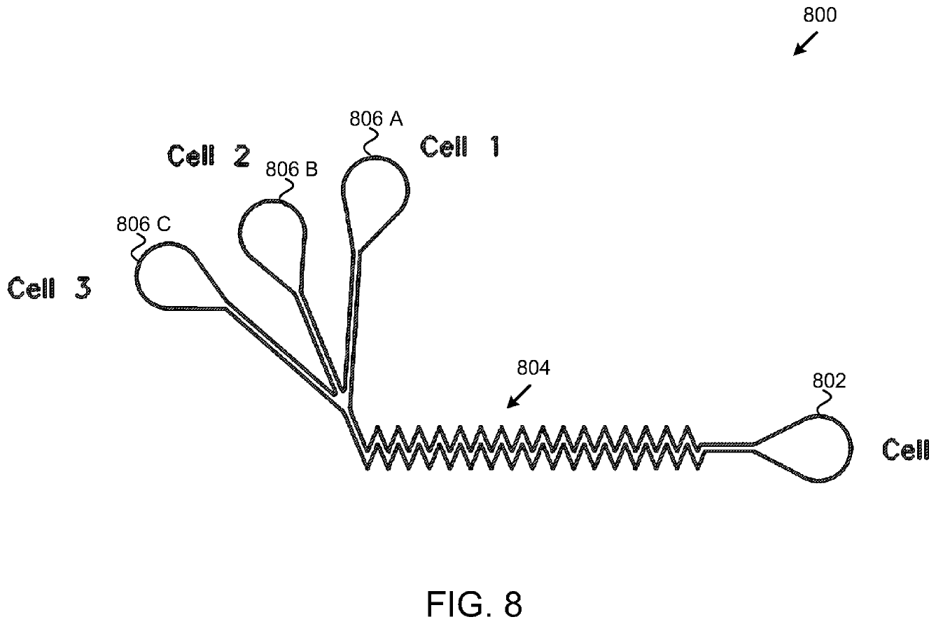

FIG. 8 is an example particle separation device 800 according to a third example embodiment. As shown in FIG. 8, the length of the main channel 804 can be shorter than that of main channel 704 in FIG. 7. For instance, the length of the device 800 in FIG. 8 can include 100 micrometers, where length of the device 700 in FIG. 7 can include 200 micrometers (although any dimensions can be used). The height of the device 800 can be 50 micrometers.

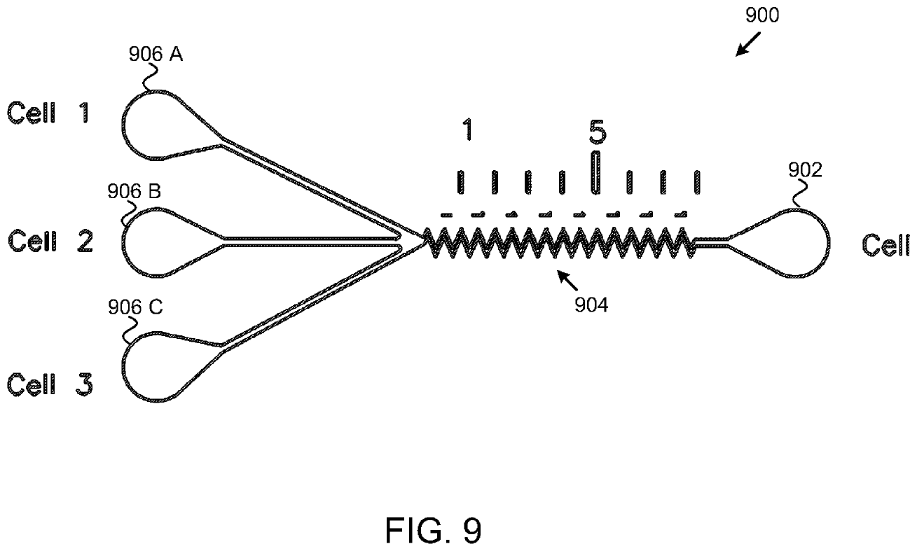

FIG. 9 is an example particle separation device 900 according to a fourth example embodiment. The device 900 in FIG. 9 can be 50 micrometers tall, 100 micrometers wide (although any dimensions can be used), and can flow from right to left.

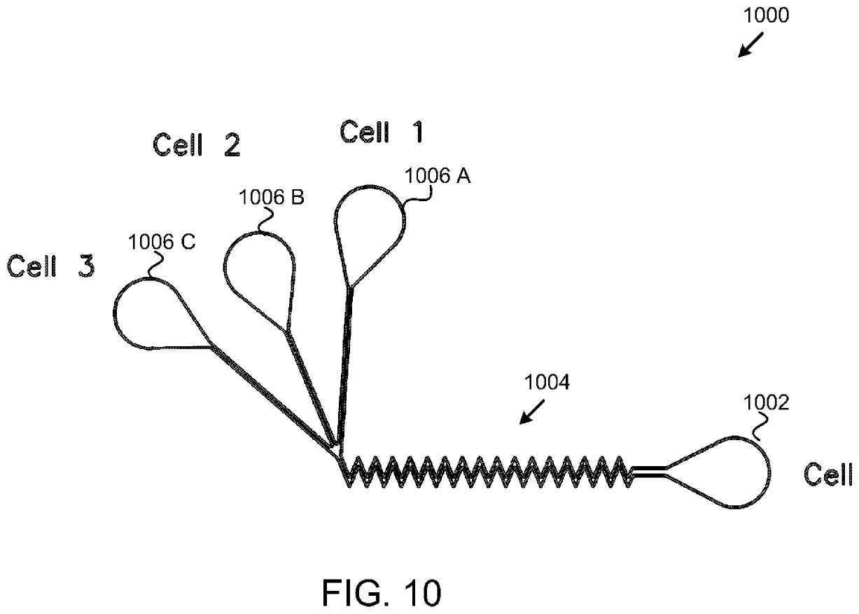

FIG. 10 is an example particle separation device 1000 according to a fifth example embodiment. The device 1000 in FIG. 10 can be 50 micrometers tall, 100 micrometers wide (although any dimensions can be used), and can flow from right to left. Furthermore, the device 1000 can include outlets 1006A-C disposed at an angle relative to the main channel 1004.

FIG. 11 is an example particle separation device 1100 according to a sixth example embodiment. As shown in FIG. 11, the device 1100 can include multiple stages 1104, 1108 of the main channel. The first stage 1104 can be directly connected to two outlets 1106A-B, and the second stage 1108 can be connected to three other outlets 1110A-C. This type of arrangement can be used in any device described herein.

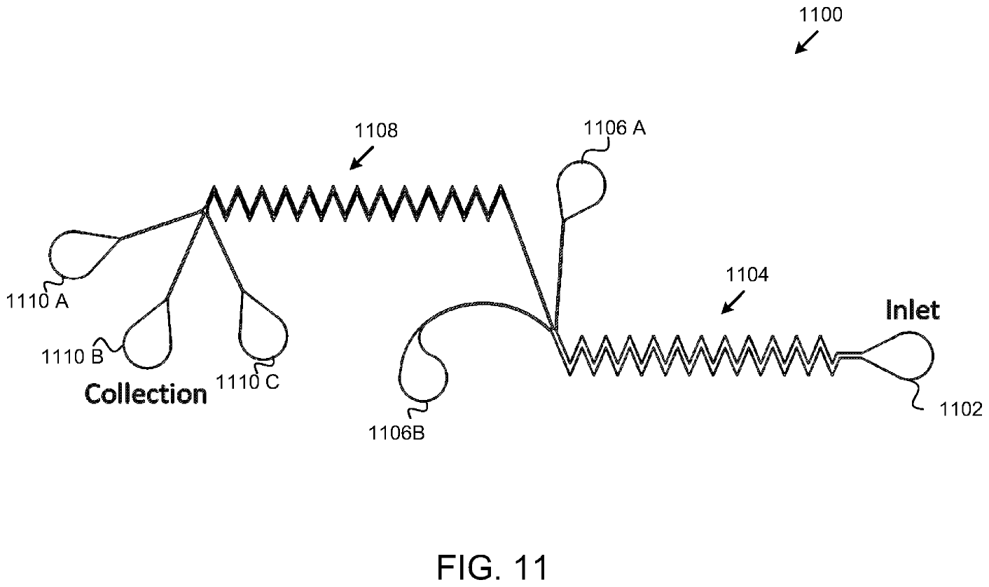

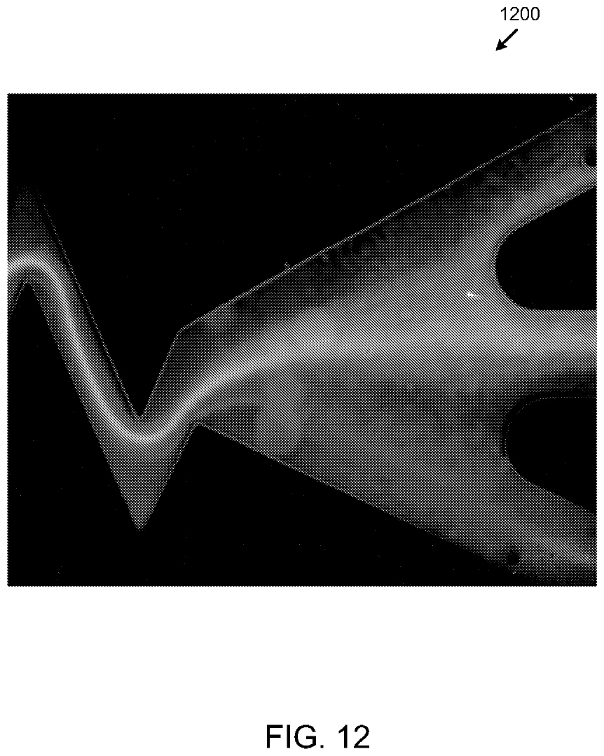

FIG. 12 is an illustration of blood components and white blood cells (WBCs) in a particle separation device. For example, particles can flow through the device as described herein. The particles can include blood components (e.g., red blood cells) and WBCs at 275 μL/min. The particles can be separated into various outlets as described herein.

FIGS. 13A-B provide illustrations 1300A-B of blood components in a brightfield image and a fluorescence image in a particle separation device. As shown in FIG. 13A, blood components can be shown in a brightfield image. In FIG. 13B, a cancer cell line can be shown as a light portion in a fluorescence image with a rate of 1.0 A at 200 μL/min. The particles can flow through a particle separation device as described herein.

As described above, a main channel of any device described herein can include a series of portions forming corners between adjacent portions. The corners can form angles around 45 degrees. The point between portions can be truncated on top or bottom with a curve or flat surface. In some instances, sharp angles (e.g., less than 90 degrees such as 89, 80, 70, 60, 50, 40, 30, 20 or less) can be used to strengthen the inertial separation. For instance, a device can include repeating 45° angles to achieve inertial separation for a range of particle sizes. Other embodiments can include obtuse angles (>90 degrees) resulting in trapezoidal corners.

Alternate embodiments could combine acute and obtuse angles in the same corner. Other embodiments could soften the corner by substituting one of the angled corners with a rounded edge. The angle degree may not have to be consistent from corner to corner but can fluctuate to achieve desired outcomes.

In some instances, the focusing pattern can be changed by increasing or decreasing the length (100 μm to 1000 μm) between corners in the device as shown with devices as described herein (e.g., device 800 in FIG. 8, device 900 in FIG. 9). Furthermore, a flow rate at which the desired focusing pattern occurs can be changed by channel width and height independently or paired.

In some instances, the devices as described herein can be applied to the inertial separation using microfluidic devices with operating Reynolds numbers (Re) in the laminar flow regime (Re<2000). The devices can include Reynolds number up to Re=2000 and focusing can still be observed. The focusing may continue to be observed throughout the laminar flow regime.

In some instances, the device can be combined into multi-stage systems to achieve enhanced sorting performance in terms of increased depletion rate and/or purity for specific types of particles.

The design of the outlet, including (1) the orientation of outlet channel with respect to the orientation of the channel and its relative location to the sharp angle, (2) the expansion ratio of the diverging channel connecting to the exit of the channel, (3) the dimensions of the outlet channels, and (4) the difference in resistance between the various outlet channels can be adjusted to selectively sort out the specific particles into the desired output channels.

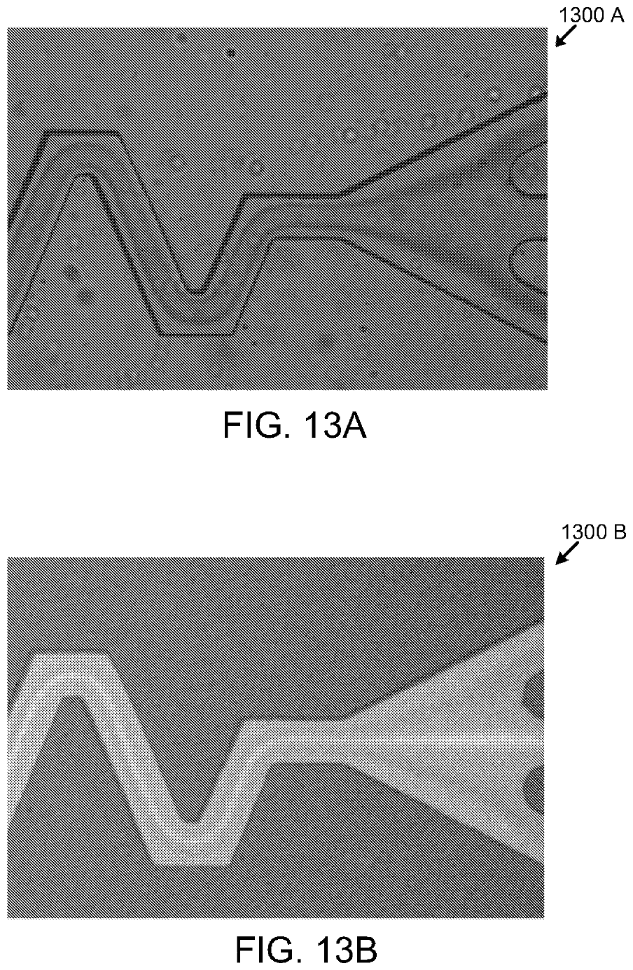

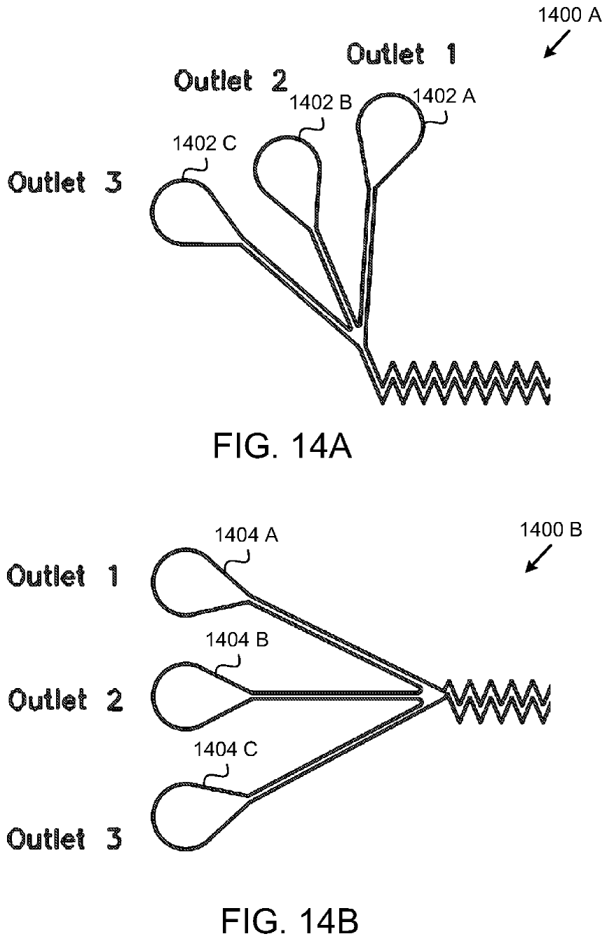

FIGS. 14A-B illustrate different orientations of the outlets. For example, in FIG. 14A, the outlets 1402A-C can be aligned with the main channel angle. In FIG. 14B, the outlets 1404A-C can be horizontal and independent of the main channel angle. The width of the channel can change continuously or abruptly for focusing the cell/particles.

The devices may have more corners than necessary to achieve focusing. The devices can operate as designed with fewer corners as well. Once focused, the cells may stay focused. The devices can operate as designed no matter how many corners are added to the device. Furthermore, the devices as described herein can include optimization of design parameters to achieve the best cell sorting performance in terms of the extraction rate of desired cell types and the depletion rate of unwanted cell types at desired flow conditions (e.g., flow rate, type of fluids).

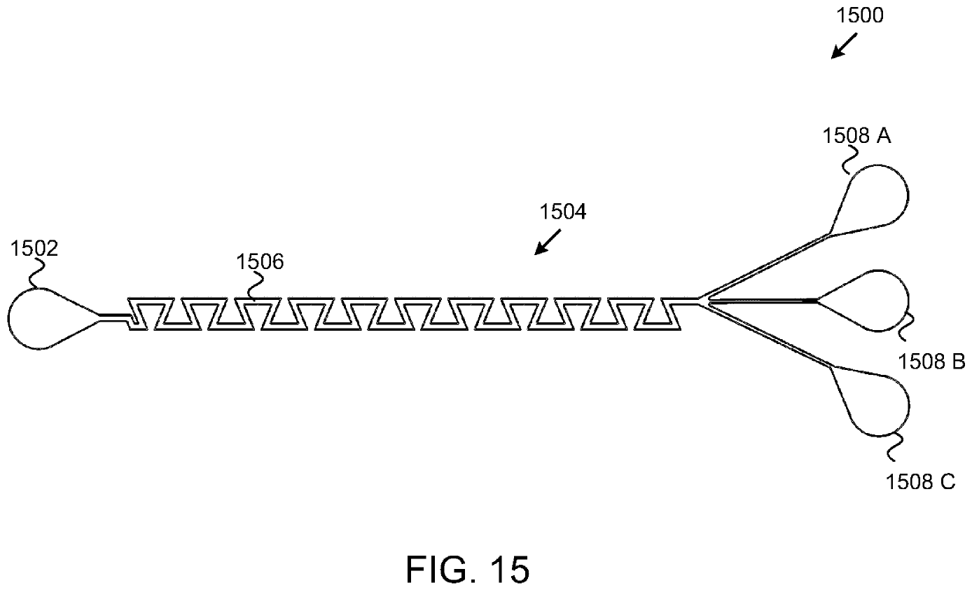

In some instances, the particle separation device can include edges forming a trapezoidal shape. FIG. 15 illustrates an example particle separation device 1500 with edges of a main channel forming a trapezoidal shape. As shown in FIG. 15, the device 1500 can include an inlet 1502, a main channel 1504, and a series of outlets 1508A-C. The main channel 1504 can include a series of edges that are less than 90 degrees. Two of the edges can form a trapezoidal shape 1506. This type of channel can be used in any device described herein.

In one embodiment, a particle separation device is described. A particle separation device (e.g., 100) can include an inlet (e.g., 102) for receiving particles of varying sizes across varying flow rates. The particle separation device can also include a main channel (e.g., 104) comprising a first end and a second end. The first end can be connected to the inlet (e.g., 102). The main channel can comprise a series of angled portions, with each of the angled portions forming an angle (e.g., edge connecting portions 204A) of less than or greater than 90 degrees relative to an adjacent angled portion. The main channel can be configured to provide an inertial separation of the particles received at the inlet. The particle separation device can also include one or more outlets (e.g., 106A-C) connected to a second end of the main channel. Each of the one or more outlets can be configured to receive separated particles of differing sizes.

In some instances, at least a portion of edges connecting each of the series of angled portions with the adjacent angled portion are rounded (e.g., edge 304A).

In some instances, the particle separation device can include between three and 20 outlets (e.g., three outlets 106A-C in FIG. 1, five outlets 508A-E in FIG. 5). The particle separation devices as described herein can include any number of outlets, such as 2, 3, 4, 5, 6, 7, 8, 9, 10, 15, 20 or more outlets, for example.

In some instances, a main channel comprises: a first stage and a second stage, wherein both the first stage and the second stage of the main channel are directly connected to at least one of the outlets. For example, in FIG. 4, outlet 408A can be connected to first stage 404, while outlets 408B-D can be connected to the second stage 406 of the main channel.

In some instances, a second channel is disposed between the first stage and the second stage of the main channel, the second channel connecting to a first outlet.

In some instances, a second channel is disposed between the first stage and the second stage of the main channel, the second channel including two open ends, with each open end connecting to corresponding outlets (e.g., 508A-B).

In some instances, any of the particle separation devices described herein has height of about 10-100 micrometers (e.g., about 10, 20, 30, 40, 50, 60, 70, 80, 90, 100 or more micrometers). In some instances, any of the particle separation devices described herein has a width or length of about 50-500 micrometers (e.g., about 10, 20, 30, 40, 50, 60, 70, 80, 90, 100, 200, 300, 400, 500 or more micrometers). In an aspect any of the particle separation devices described herein comprise a height of about 50 micrometers and a width or length of between about 100-200 micrometers.

In some instances, the first stage of the main channel comprises a width of around 200 micrometers and wherein the second stage of the main channel comprises a width of around 100 micrometers.

In some instances, the particle separation device is configured to operate in a laminar flow regime and a transitional flow regime.

In some instances, the particle separation device is configured to operate in a laminar flow regime with a Reynolds number that is less than or equal to 2000 (e.g., less than about 2,000, 1,750, 1,500, 1,250, 1,000, 750, 500, or 250).

In some instances, the one or more outlets are either disposed in-line with the main channel (e.g., in FIG. 14B) or are disposed offset relative to a direction of the main channel (e.g., in FIG. 14A). In an aspect an outlet is offset from a main channel by about 20, 30, 45, 50, 60, 70, 80, 90, 100, 120, 130, 140, 150, 160, 170, or 175 degrees, but any amount of offset is contemplated.

In another example embodiment, a system for separating particles of varying sizes across varying flow rates using inertial separation is provided. The system can include an inlet and a main channel connected to the inlet at a first end of the main channel. The main channel can include a series of angled portions. The system can also include a set of outlets connected to a second end of the main channel.

In some instances, the system comprises a Reynolds number of less than 2000 (e.g., less than about 2,000, 1,750, 1,500, 1,250, 1,000, 750, 500, or 250).

In some instances, at least two of the series of angled portions including angles greater than 90 degrees form a trapezoidal corner.

In some instances, a first portion of the series of angled portions form trapezoidal corners and a second portion of the series of angled portions include rounded edges.

In some instances, at least one edge connecting each of the series of angled portions with adjacent angled portions is rounded.

In another example embodiment, a device is provided. The device can include an inlet (e.g., 402 in FIG. 4) for receiving particles of varying sizes across varying flow rates. The device can also include a main channel comprising a first stage (e.g., 404) and a second stage (e.g., 406), with a first end of the first stage of the main channel connected to the inlet. The main channel can include a series of angled portions. The main channel can be configured to provide an inertial separation of the particles received at the inlet. The device can also include at least two outlets, with at least a first outlet (e.g., 408A) connected to the first stage of the main channel and a second outlet (e.g., 408B-D) connected to the second stage of the main channel.

In some instances, each of the angled portions forming an angle with an adjacent angled portion that is either less than or greater than 90 degrees.

In some instances, the first stage comprises angled portions forming angles less than 45 degrees and the second stage comprises angled portions that are greater than 90 degrees forming trapezoidal corners. In another instance, the first stage comprises angled portions that are greater than 90 degrees forming trapezoidal corners, and the second stage comprises angled portions forming angles less than 45 degrees.

In some instances, any of the first stage or second stage comprises angled portions forming angles less than 45 degrees that form trapezoidal corners.

### Two Stage Inertial Sorter Devices

Two stage inertial sorter devices are also provided. A trapezoidal-sawtooth inertial (TSI) device is provided. See FIG. 16. In this device, larger particles, such as cells, which have more inertia undergo dual focusing: the initial stage features a trapezoidal profile, followed by a second stage with a sawtooth profile. In a blood sample, the majority of red blood cells are directed towards the side outlets in both stages, while the ultimate enriched sample is gathered from the central outlet 1608C, however, cells can be focused to any desired outlet, for example to 1608 B, C, and D; or 1608A and E, or 1608A, etc. The depth of the channel can be, for example, between about 30 μm and about 70 μm (e.g., about 30, 40, 50, 60, 70 μm or between about 40 μm and about 60 μm). The width of the main channels can be about 50, 100, 150, 200, 250 μm or more. In an aspect a first stage main channel 1604 (e.g., a trapezoidal profile main channel) can have a width of about 50, 100, 150, 200, 250 μm or more. A first stage main channel can be about 10 mm to about 30 cm in length (e.g., about 10, 20, 30, 40, 50, 60, 70, 80, 90 100 mm or more, or about 1, 2, 5, 10, 15, 20, 25, 30 mm or more). In an aspect a second stage main channel 1606 (i.e., a sawtooth profile main channel) can have a width of about 50, 100, 150, 200, 250 μm or more. A second stage main channel can be about 10 mm to about 30 cm in length (e.g., about 10, 20, 30, 40, 50, 60, 70, 80, 90 100 mm or more, or about 1, 2, 5, 10, 15, 20, 25, 30 mm or more). In an aspect, a first stage main channel (e.g., a trapezoidal profile main channel) can have a width of about 200 μm and a second stage main channel (e.g., a sawtooth profile main channel) can have a width of about 100 μm. A wavelength of the trapezoidal or sawtooth profile can be about 0.1, 0.2, 0.25, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5 mm or more. In an aspect, a trapezoidal profile can have a wavelength of about 1.0 mm to about 3.0 mm. In an aspect, a sawtooth profile can have a wavelength of about 0.25 mm to about 2 mm. In an aspect, a device has a trapezoidal profile with have a wavelength of about 1.0 mm to about 3.0 mm. In an aspect, a sawtooth profile can have a wavelength of about 0.25 mm to about 2 mm. In an aspect, a device can have a trapezoidal profile with a wavelength of about 1.45 mm and a sawtooth profile with a wavelength of about 0.5 mm.

Therefore, a particle separation device can comprise an inlet for receiving particles of varying sizes and/or differing inertia across varying flow rates. A device can further comprise a main channel comprising a first stage and a second stage, the first stage comprising a first end connected to the inlet and a second end connected to the second stage. the second stage can comprise 2, 3, 4, 5, or more channels each connected to one or more outlets. The first and second stage can comprise a channel comprising a series of angled portions, with each of the angled portions forming an angle of either less than or greater than 90 degrees (e.g., any acute angle between 1-89 degrees (e.g., 1, 5, 10, 15, 20, 25, 30, 40, 45, 50, 55, 60, 65, 70, 75, 80, 85, or 89 degrees), or an obtuse angle between 91-179 degrees (e.g., 91, 95, 100, 105, 110, 115, 120, 125, 130, 135, 140, 145, 150, 155, 160, 165, 170, 175, or 179 degrees)) to an adjacent angled portion. The angle formed in the first and second stage channel is configured to provide an inertial separation of the particles. Each of the one or more outlets can be configured to receive separated particles of differing sizes and/or differing inertia. The series of angled portions of the first stage channel can be different from the series of angled portions of the second stage channels. For example, the series of angled portions of the first stage channel can be trapezoidal wave shaped, and the series of angled portion of the second stage channels can be sawtooth wave shaped. The series of angled portions of the first stage channel can be sawtooth wave shaped, and the series of angled portion of the second stage channels can be trapezoidal wave shaped. The angled portions can have a wavelength of, for example, 0.1 mm to 5 mm (e.g., about 0.1, 0.2, 0.25, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0 mm or more. The first and second stages can be the same or different lengths. In an aspect the second stage is shorter than the first stage. In an aspect the first stage is shorter than the second stage.

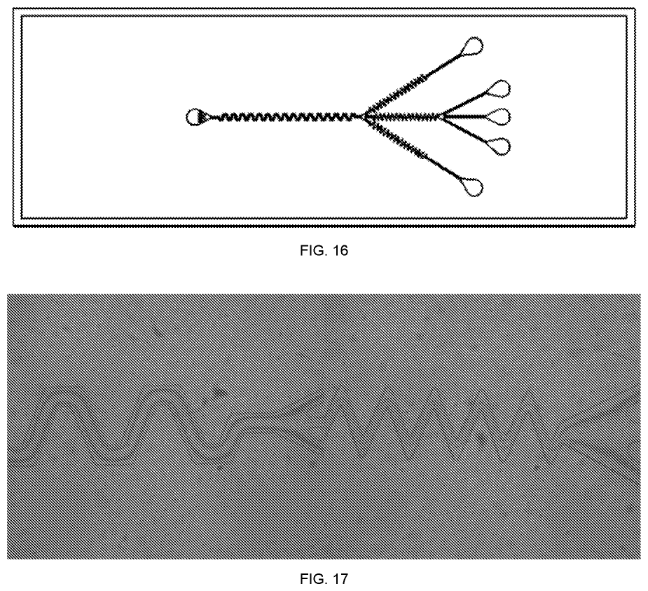

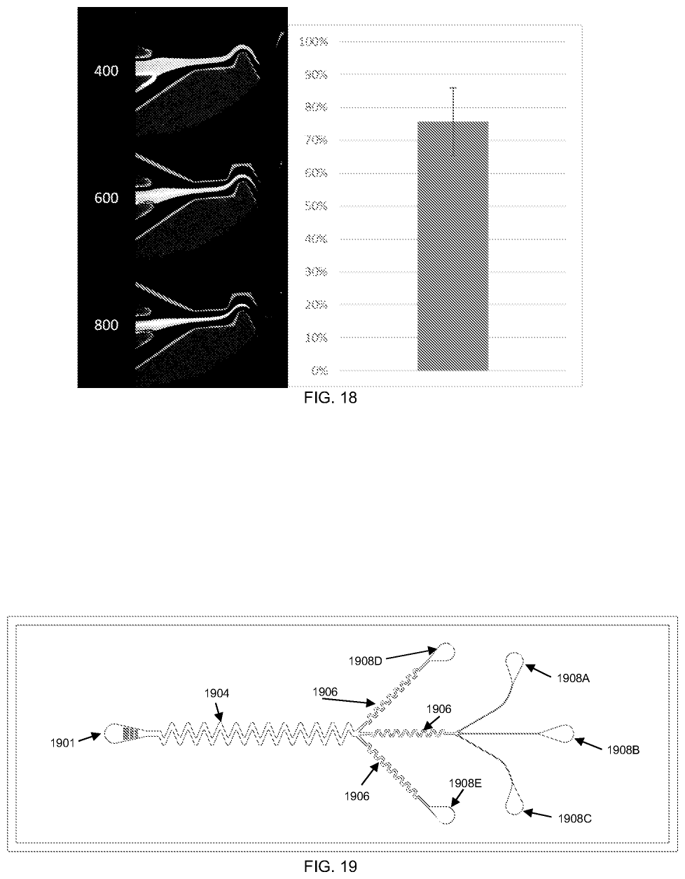

This type of device can be used to, for example, deplete red blood cells from a biological sample. FIG. 17 shows depletion of red blood cells from a diluted (10×) blood sample in both stages of the TSI device. FIG. 18 shows focusing of fluorescent cancer cell lines in the first stage of a TSI device. In an example, the sample containing particles, e.g., cells is delivered into the inlet 1601 and separated particles are delivered to the outlets 1608.

Another two-stage inertial sorter device is a sawtooth-trapezoidal inertial (STI) sorter device. See e.g., FIG. 19. In this arrangement, the channel profile order is the opposite of the TSI design. Larger cells (cells with more inertia) undergo dual focusing: the initial stage features a sawtooth profile, followed by a second stage with a trapezoidal profile. Where a sample is a blood sample, the majority of red blood cells are directed towards the side outlets in both stages, while the final enriched sample is collected from the central outlet 1908B however, cells can be focused to any desired outlet, for example to however, cells can be focused to any desired outlet, for example to 1908 A, B, and C; or 1908D and E, or 1908A, etc.

The depth of the channels can be, for example, between about 30 μm and about 70 μm (e.g., about 30, 40, 50, 60, 70 μm or between about 40 μm and about 60 μm). The width of the main channels can be about 50, 100, 150, 200, 250, 300, 350, 400, 450, 500, 550, 600 μm or more. In an aspect a first stage main channel 1704 (i.e., a sawtooth profile main channel) can have a width of about 300, 350, 400, 450, 500 μm or more. A first stage main channel can be about 10 mm to about 30 cm in length (e.g., about 10, 20, 30, 40, 50, 60, 70, 80, 90 100 mm or more, or about 1, 2, 5, 10, 15, 20, 25, 30 mm or more). In an aspect a second stage main channel 1706 (i.e., a trapezoidal profile main channel) can have a width of about 50, 100, 150, 200, 250 μm or more. A second stage main channel can be about 10 mm to about 30 cm in length (e.g., about 10, 20, 30, 40, 50, 60, 70, 80, 90 100 mm or more, or about 1, 2, 5, 10, 15, 20, 25, 30 mm or more). In an aspect, a first stage main channel (i.e., a sawtooth profile main channel) can have a width of about 400 μm and a second stage main channel (i.e., a trapezoidal profile main channel) can have a width of about 200 μm. The first and second stages can be the same or different lengths. In an aspect the second stage is shorter than the first stage. In an aspect the first stage is shorter than the second stage.

A wavelength of the trapezoidal or sawtooth profile of a TSI design can be about 0.1, 0.2, 0.25, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0 mm or more. In an aspect, a sawtooth profile can have a wavelength of about 1.0 mm to about 3.0 mm. In an aspect, a trapezoidal profile can have a wavelength of about 0.25 mm to about 2 mm. In an aspect, a device has a sawtooth profile with have a wavelength of about 1.0 mm to about 3.0 mm. In an aspect, a trapezoidal profile can have a wavelength of about 0.25 mm to about 2 mm. In an aspect, a device can have a sawtooth profile with a wavelength of about 1.85 mm and a trapezoidal profile with a wavelength of about 1.45 mm.

A two-stage sawtooth-trapezoidal inertial (STI) sorter device was used to separate a diluted (10×) blood sample. In an example, the sample containing particles, e.g., cells is delivered into the inlet 1901and separated particles are delivered to the outlets1908.

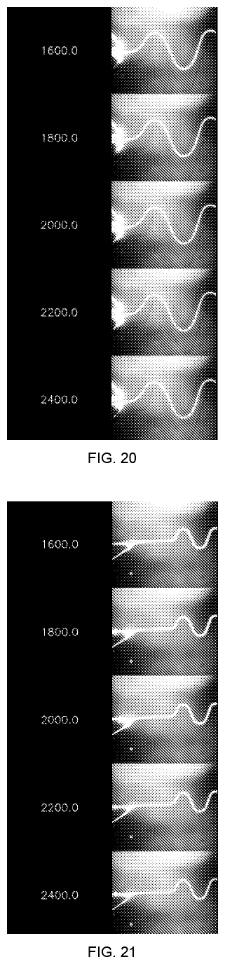

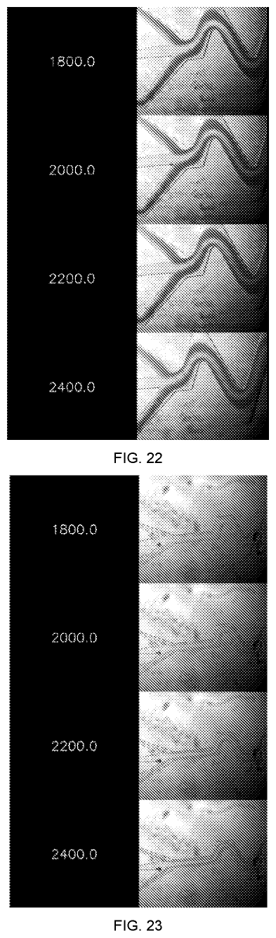

FIG. 20 shows focusing of fluorescent cancer cells in the first stage of an STI device. FIG. 21 shows focusing of fluorescent cancer cells in the second stage of an STI device. FIG. 22 shows depletion of red blood cells in the first stage of an STI device. FIG. 23 shows depletion of red blood cells in the second stage of an STI device.

### Three-Stage Inertial Sorter

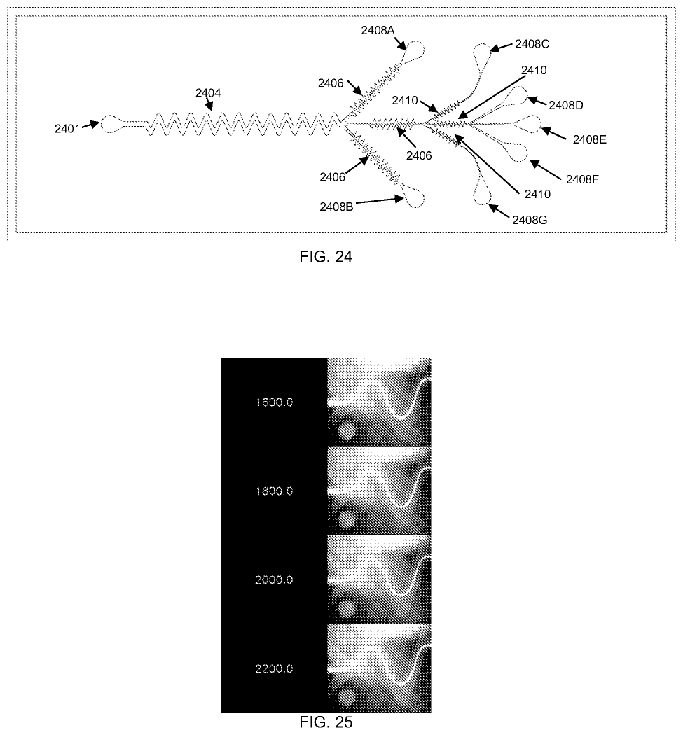

Three-stage inertial sorter devices are also provided. For example, a sawtooth-sawtooth-sawtooth inertial (SSSI) sorter device is provided. See FIG. 24. In this configuration, larger cells (cells with more inertia) undergo triple focusing: all stages feature a sawtooth profile. Where a blood sample is used, the majority of red blood cells are directed towards the side outlets in all stages, while the final enriched sample is collected from the central outlet 2408, however, cells can be focused to any desired outlet, for example to 2408C, D, E, F, and G, or 2408A and B, or 2408A, etc.

In some aspects, the depth of an SSSI sorter device can be, for example, between about 30 μm and about 70 μm (e.g., about 30, 40, 50, 60, 70 μm or between about 40 μm and about 60 μm). The width of the main channels can be about 50, 100, 150, 200, 250, 300, 350, 400, 450, 500, 550, 600 μm or more. In an aspect a first stage main channel 2404 (e.g., a sawtooth profile main channel as shown in FIG. 24, but any angle/wave form can be used, e.g., trapezoidal) can have a width of about 300, 350, 400, 450, 500 μm or more. A first stage main channel can be about 10 mm to about 30 cm in length (e.g., about 10, 20, 30, 40, 50, 60, 70, 80, 90 100 mm or more, or about 1, 2, 5, 10, 15, 20, 25, 30 mm or more). In an aspect a second stage main channel 2406 (i.e., a sawtooth profile main channel) can have a width of about 100, 150, 200, 300, 350 μm or more. A second stage main channel can be about 10 mm to about 30 cm in length (e.g., about 10, 20, 30, 40, 50, 60, 70, 80, 90 100 mm or more, or about 1, 2, 5, 10, 15, 20, 25, 30 mm or more). In an aspect a third stage main channel 2410 (i.e., a sawtooth profile main channel) can have a width of about 50, 60, 70, 80, 90, 100, 100, 150, 200 μm or more. A third stage main channel can be about 10 mm to about 30 cm in length (e.g., about 10, 20, 30, 40, 50, 60, 70, 80, 90 100 mm or more, or about 1, 2, 5, 10, 15, 20, 25, 30 mm or more). In an aspect a first stage main channel has a width of 400 μm, a second stage main channel has a width of 200 μm, and a third stage main channel has a width of 80 μm. In some aspects, a wavelength of a sawtooth profile (or trapezoidal profile) of an SSSI device can be about 0.1, 0.2, 0.25, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0 mm or more. In an aspect, a first stage sawtooth profile can have a wavelength of about 1.0 mm to about 3.0 mm. In an aspect, a second stage sawtooth profile can have a wavelength of about 0.25 mm to about 2 mm. In an aspect, a third stage sawtooth profile can have a wavelength of about 0.25 mm to about 2 mm. In an aspect, a first stage sawtooth (or trapezoidal) profile can have a wavelength of about 1.85 mm, a second stage sawtooth (or trapezoidal) profile can have a wavelength of about 0.6 mm, and a third stage sawtooth (or trapezoidal) profile can have a wavelength of about 0.45 mm. In an aspect a combination of sawtooth and trapezoidal profiled can be used. For example, a first stage can have a sawtooth or trapezoidal profile, a second stage can have a sawtooth or trapezoidal profile, and a third stage can have a sawtooth or trapezoidal profile.

Therefore, provided herein is a particle separation device comprising an inlet 2401 for receiving particles of varying sizes and/or differing inertia across varying flow rates. A device can comprise a main channel comprising a first stage, a second stage, and a third stage. The first stage can comprise a first end connected to the inlet and a second end connected to the second stage. The second stage can comprise 2, 3, 4, 5, or more channels each connected to one or more outlets and one channel connected to the third stage. The third stage can comprise 2, 3, 4, 5, or more channels each connected to one or more outlets. The first, second, and third stages can further comprise a channel comprising a series of angled portions, with each of the angled portions forming an angle of either less than or greater than 90 degrees to an adjacent angled portion, where the angle formed in the channel is configured to provide an inertial separation of the particles, Each of the one or more outlets can be configured to receive separated particles of differing sizes and/or differing inertia. The series of angled portions of the first stage channel can be trapezoidal wave shaped or sawtooth wave shaped, the series of angled portions of the second stage channels can be trapezoidal wave shaped or sawtooth wave shaped, and the series of angled portions of the third stage channels can be trapezoidal or sawtooth wave shaped.

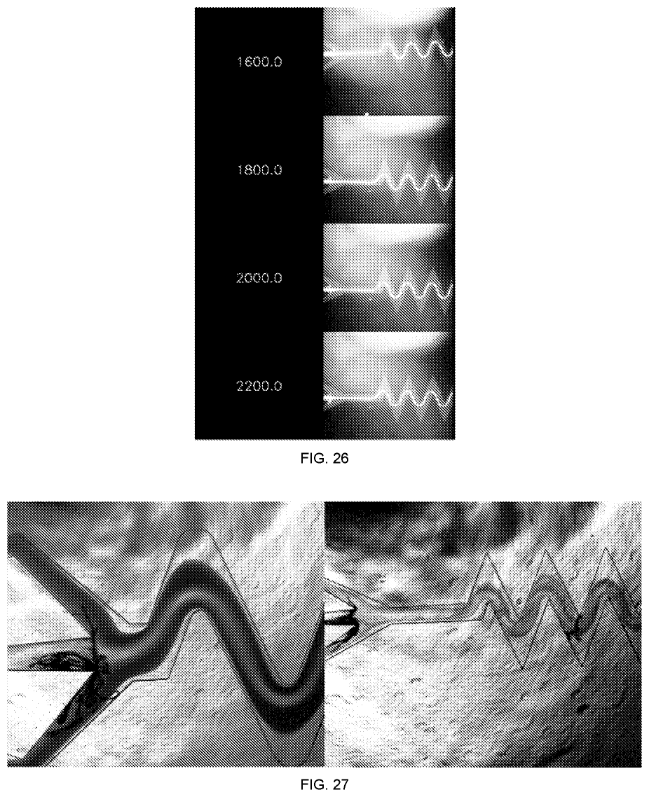

In an example, the sample containing particles, e.g., cells, is delivered into the inlet 2401 and separated particles are delivered to the outlets 2408. FIG. 25 shows focusing of cancer cell lines in the first stage of an SSSI device (e.g., FIG. 24). FIG. 26 shows focusing of cancer cell lines in the second stage of an SSSI device (e.g. FIG. 24). FIG. 27 shows depletion of red blood cells in the first two stages of an SSSI device (e.g., FIG. 24).

### Methods of Separation

Particles can be separated based on differing sizes and/or differing inertia within channels of the devices described herein. One or more particles from a mixture of particles suspended in a liquid can be introduced into an inlet of any of the particle separation devices described herein and particles can be collected from the one or more outlets.

A sample can be a fluid sample comprising particles of different sizes and/or inertia. In an aspect a sample comprises cells or a mixture of cells, a biological sample, blood, serum, stem cells, bone marrow cells, circulating tumor cells, released tumor cells, or mixtures thereof. A sample can be any type of sample comprising cells from, e.g., a patient or cells from a cell culture. In an aspect, the cell sample can comprise red blood cells, white blood cells, and/or cancerous cells. In an aspect, cancerous cells can be separated from other cells in a sample. In an aspect, cancerous cells can be enriched from other cells in a sample. In an aspect, red blood cells can be depleted from a sample. A sample can be introduced into a device described herein using a variety of techniques, for example, using a syringe and/or a pump.

It will be understood that terms such as “top,” “bottom,” “above,” “below,” and x-direction, y-direction, and z-direction as used herein as terms of convenience that denote the spatial relationships of parts relative to each other rather than to any specific spatial or gravitational orientation. Thus, the terms are intended to encompass an assembly of component parts regardless of whether the assembly is oriented in the particular orientation shown in the drawings and described in the specification, upside down from that orientation, or any other rotational variation.

The compositions and methods described herein are illustrative only, as numerous modifications and variations therein will be apparent to those skilled in the art. The terms used in the specification generally have their ordinary meanings in the art, within the context of the compositions and methods described herein, and in the specific context where each term is used. Some terms have been more specifically defined herein to provide additional guidance to the practitioner regarding the description of the compositions and methods.

As used herein, the term “and/or” includes any and all combinations of one or more of the associated listed items. As used in the description herein and throughout the claims that follow, the meaning of “a”, “an”, and “the” includes plural reference as well as the singular reference unless the context clearly dictates otherwise. The term “about” in association with a numerical value means that the value varies up or down by 5%. For example, for a value of about 100, means 95 to 105 (or any value between 95 and 105).

All patents, patent applications, and other scientific or technical writings referred to anywhere herein are incorporated by reference herein in their entirety. The embodiments illustratively described herein suitably can be practiced in the absence of any element or elements, limitation or limitations that are specifically or not specifically disclosed herein. Thus, for example, in each instance herein any of the terms “comprising,” “consisting essentially of,” and “consisting of” can be replaced with either of the other two terms, while retaining their ordinary meanings. The terms and expressions which have been employed are used as terms of description and not of limitation, and there is no intention that in the use of such terms and expressions of excluding any equivalents of the features shown and described or portions thereof, but it is recognized that various modifications are possible within the scope of the claims.

Thus, it should be understood that although the present methods and compositions have been specifically disclosed by embodiments and optional features, modifications and variations of the concepts herein disclosed can be resorted to by those skilled in the art, and that such modifications and variations are considered to be within the scope of the compositions and methods as defined by the description and the appended claims.

Any single term, single element, single phrase, group of terms, group of phrases, or group of elements described herein can each be specifically excluded from the claims.

Whenever a range is given in the specification, for example, a temperature range, a time range, a composition, or concentration range, all intermediate ranges and subranges, as well as all individual values included in the ranges given are intended to be included in the disclosure. It will be understood that any subranges or individual values in a range or subrange that are included in the description herein can be excluded from the aspects herein. It will be understood that any elements or steps that are included in the description herein can be excluded from the claimed compositions or methods

In addition, where features or aspects of the compositions and methods are described in terms of Markush groups or other grouping of alternatives, those skilled in the art will recognize that the compositions and methods are also thereby described in terms of any individual member or subgroup of members of the Markush group or other group.

What is claimed is:

1. A particle separation device comprising:
an inlet for receiving particles of varying sizes and/or differing inertia across varying flow rates;
a main channel comprising a first end and a second end, the first end connected to the inlet, the main channel comprising a series of angled portions, with each of the angled portions forming an angle of either less than or greater than 90 degrees to an adjacent angled portion, where the angle formed in the main channel is configured to provide an inertial separation of the particles received at the inlet; and
one or more outlets connected to a second end of the main channel, each of the one or more outlets configured to receive separated particles of differing sizes and/or differing inertia.

2. The particle separation device of claim 1, wherein at least a portion of edges connecting each of the series of angled portions with the adjacent angled portion are rounded.

3. The particle separation device of claim 1, wherein the series of angled portions reduce a pressure in the particle separation device and control varying flow rates of particles received at the inlet.

4. The particle separation device of claim 1, comprising between three and nine outlets.

5. The particle separation device of claim 1, wherein the main channel comprises:
a first stage and a second stage, wherein both the first stage and the second stage of the main channel are directly connected to at least one of the outlets.

6. The particle separation device of claim 5, wherein a second channel is disposed between the first stage and the second stage of the main channel, the second channel connecting to a first outlet.

7. The particle separation device of claim 5, wherein a second channel is disposed between the first stage and the second stage of the main channel, the second channel including two open ends, with each open end connecting to corresponding outlets.

8. The particle separation device of claim 1, wherein the particle separation device comprises a height of 50 micrometers and a width of between 100-200 micrometers.

9. The particle separation device of claim 5, wherein the first stage of the main channel comprises a length of around 200 micrometers and wherein the second stage of the main channel comprises a length of around 100 micrometers.

10. The particle separation device of claim 1, wherein the particle separation device is configured to operate in a laminar flow regime and a transitional flow regime.

11. The particle separation device of claim 1, wherein the particle separation device includes a Reynolds number that is less than or equal to 2000.

12. The particle separation device of claim 1, wherein the one or more outlets are either disposed in-line with the main channel or are disposed offset relative to a direction of the main channel.

13. The particle separation device of claim 1, wherein the angled portions are trapezoidal wave shaped or sawtooth wave shaped.

14. The particle separation device of claim 1, wherein the angled portions have a wavelength of 0.1 mm to 5 mm.

15. The particle separation device of claim 1, wherein the main channel has a width of 50 to 600 micrometers and a depth of 30 to 70 micrometers.

16. A particle separation device for separating particles of varying sizes and differing inertia across varying flow rates using inertial separation, the system comprising:
an inlet;
a main channel connected to the inlet at a first end of the main channel, the main channel comprising a series of angled portions, wherein each of the angled portions forming an angle that is greater than 90 degrees to an adjacent angled portion; and
a set of outlets connected to a second end of the main channel.

17. The particle separation device of claim 16, wherein the system comprises a Reynolds number of less than 2000.

18. The particle separation device of claim 16, wherein at least two of the series of angled portions including angles greater than 90 degrees form a trapezoidal corner.

19. The particle separation device of claim 18, wherein a first portion of the series of angled portions form trapezoidal corners and a second portion of the series of angled portions include rounded edges.

20. The particle separation device of claim 16, wherein the angled portions are trapezoidal wave shaped or sawtooth wave shaped.

21. The particle separation device of claim 16, wherein the angled portions have a wavelength of 0.1 mm to 5 mm.

22. The particle separation device of claim 16, wherein the main channel has a width of 50 to 600 micrometers and a depth of 30 to 70 micrometers.

23. A particle separation device comprising:
an inlet for receiving particles of varying sizes and differing inertia across varying flow rates;
a main channel comprising a first stage and a second stage, with a first end of the first stage of the main channel connected to the inlet, the main channel comprising a series of angled portions, the main channel configured to provide an inertial separation of the particles received at the inlet; and
at least two outlets, with at least a first outlet connected to the first stage of the main channel and a second outlet connected to the second stage of the main channel.

24. The particle separation device of claim 23, wherein each of the angled portions forming an angle with an adjacent angled portion that is either less than 45 degrees or greater than 90 degrees.

25. The particle separation device of claim 24, wherein the first stage comprises angled portions forming angles less than 45 degrees and the second stage comprises angled portions that are greater than 90 degrees forming trapezoidal corners.

26. The particle separation device of claim 23, wherein the first stage comprises angled portions that are trapezoidal wave shaped or sawtooth wave shaped and wherein the second stage comprises angled portions that are trapezoidal wave shaped or sawtooth wave shaped.

27. The particle separation device of claim 23, wherein the angled portions have a wavelength of 0.1 mm to 5 mm.

28. The particle separation device of claim 23, wherein the main channel has a width of 50 to 600 micrometers and a depth of 30 to 70 micrometers.

29. The particle separation device of claim 24, wherein any of the first stage or second stage comprises angled portions forming angles less than 45 degrees that form trapezoidal corners.

30. A particle separation device comprising:
an inlet for receiving particles of varying sizes and/or differing inertia across varying flow rates;
a main channel comprising a first stage and a second stage, the first stage comprising a first end connected to the inlet and a second end connected to the second stage, the second stage comprising 2, 3, 4, 5, or more channels each connected to one or more outlets, wherein the first stage comprises a channel comprising a series of angled portions, with each of the angled portions forming an angle of either less than or greater than 90 degrees to an adjacent angled portion, where the angle formed in the first stage channel is configured to provide an inertial separation of the particles, wherein the channels of the second stage comprise a series of angled portions, with each of the angled portions forming an angle of either less than or greater than 90 degrees to an adjacent angled portion, where the angle formed in the second stage channels is configured to provide an inertial separation of the particles, wherein each of the one or more outlets is configured to receive separated particles of differing sizes and/or differing inertia.

31. The particle separation device of claim 30, wherein the series of angled portions of the first stage channel are different from the series of angled portions of the second stage channels.

32. The particle separation device of claim 30, wherein the series of angled portions of the first stage channel are trapezoidal wave shaped, and the series of angled portion of the second stage channels are sawtooth wave shaped.

33. The particle separation device of claim 30, wherein the series of angled portions of the first stage channel are sawtooth wave shaped, and the series of angled portion of the second stage channels are trapezoidal wave shaped.

34. The particle separation device of claim 30, wherein the angled portions have a wavelength of 0.1 mm to 5 mm.

35. A particle separation device comprising:
an inlet for receiving particles of varying sizes and/or differing inertia across varying flow rates;
a main channel comprising a first stage, a second stage, and a third stage, the first stage comprising a first end connected to the inlet and a second end connected to the second stage, the second stage comprising 2, 3, 4, 5, or more channels each connected to one or more outlets and one channel connected to the third stage, the third stage comprising 2, 3, 4, 5, or more channels each connected to one or more outlets, the first stage further comprising a channel comprising a series of angled portions, with each of the angled portions forming an angle of either less than or greater than 90 degrees to an adjacent angled portion, where the angle formed in the first stage channel is configured to provide an inertial separation of the particles, wherein the channels of the second stage comprise a series of angled portions, with each of the angled portions forming an angle of either less than or greater than 90 degrees to an adjacent angled portion, where the angle formed in the second stage channels is configured to provide an inertial separation of the particles, wherein the channels of the third stage comprise a series of angled portions, with each of the angled portions forming an angle of either less than or greater than 90 degrees to an adjacent angled portion, where the angle formed in the third stage channels is configured to provide an inertial separation of the particles, wherein each of the one or more outlets is configured to receive separated particles of differing sizes and/or differing inertia.

36. The particle separation device of claim 35, wherein the series of angled portions of the first stage channel are trapezoidal wave shaped or sawtooth wave shaped, the series of angled portions of the second stage channels are trapezoidal wave shaped or sawtooth wave shaped, and the series of angled portions of the third stage channels are trapezoidal or sawtooth wave shaped.

37. The particle separation device of claim 30, wherein the angled portions have a wavelength of 0.1 mm to 5 mm.

38. A method for separating one or more particles from a mixture of particles suspended in a liquid, comprising introducing the mixture into an inlet of a particle separation device of any of claims 1, 16, 23, 30, and 35 and collecting particles from the one or more outlets.

39. The method of claim 38, wherein the particles are cells or a mixture of cells.

40. The method of claim 39, wherein the cells are blood cells, stem cells, bone marrow cells, circulating tumor cells, released tumor cells, or mixtures thereof.
